(19) United States
(12) Patent Application Publication
(10) Pub. No.: US 2006/0060243 A1
(43) Pub. Date: Mar. 23, 2006

(54) Self-draining vacuum breaker

(76) Inventor: Yung-Fang Yang, Changhua County (TW)

Correspondence Address: BACON & THOMAS, PLLC, 625 SLATERS LANE, FOURTH FLOOR, ALEXANDRIA, VA, 22314, US

(21) Appl. No.: 10/945,911

(22) Filed: Sep. 22, 2004

(51) Int. Cl. F16K 24/00

(52) U.S. Cl. 137/218

(57) ABSTRACT

A self-draining vacuum breaker includes a tubular first valve, an internally-stepped tubular second valve, a circular diaphragm, a movable stopper, and a spring. The first valve includes an inlet formed at an end and thereof, and a coupling end formed at the other end thereof and having an external thread. The second valve includes a coupling portion formed at an end thereof and having a thread hole, and an outlet formed at the other end thereof, and a recess formed in the thread hole for jamming said circular diaphragm and having an outlet hole. A stepped portion is formed between the thread hole and the outlet hole, having a plurality of vent holes running therethrough for communicating with outside. Therefore, when the self-draining vacuum breaker is connected between an outfall and a hose, the air can be brought into the hose to eliminate the vacuum.

### BACKGROUND OF THE INVENTION

1. Field of the Invention

The present invention relates generally to drainage system, and more particularly to a self-draining vacuum breaker, which can immediately eliminate the vacuum formed in the hose and further drain the water remaining in the hose.

2. Description of the Related Art

There are automatic sprinkler systems mounted in most of the common farms, greenhouses, and courtyards for regularly providing the plants with water. When the automatic sprinkler system is working, the water flows out of a faucet, passes by the underground hose, then reaches the sprinkler in the garden, and finally sprays out through the sprinkler. When the sprinkler finishes the work and turns off the faucet to stop watering, there is still water remaining in the hose. Meanwhile, the faucet is sealed to generate vacuum in the hose, thereby preventing the remaining water from drainage. Further, if the automatic sprinkler system is located at high latitude regions and once the temperature suddenly drops to the freezing point, the remanent water in the hose will freeze to obstruct the hose and to potentially further rupture the hose due to the expansion incurred while the water transforms into ice. Hence, the user has to repair the hose or reinstall the hose underground, thereby causing a great trouble for the user.

Referring to FIG. 1, a conventional self-draining vacuum breaker 1, which is comprised of two valves 3 and 4 and a circular diaphragm 2 held in position between the two valves 3 and 4, can eliminate the vacuum in the hose to further solve the above problem. However, the circular diaphragm 2 is held in position merely by the two valves 3 and 4 to be insufficient in structural strength, such that when the water pressure is greatly high and the water flow is huge, the circular diaphragm 2 is vulnerable to the impact of the huge water flow and therefore is subject to departure from the original position to further cause malfunction of the conventional self-draining vacuum breaker 1. In addition, the conventional self-draining vacuum breaker 1 is structurally complex to be high-cost in production, and therefore an improvement is necessary.

### SUMMARY OF THE INVENTION

The primary objective of the present invention is to provide an improved self-draining vacuum breaker, which is structurally simple and durable.

The foregoing objective of the present invention is attained by the improved self-draining vacuum breaker, which is connected between an outfall and a hose and comprised of a tubular first valve, an internally-stepped tubular second valve, a circular diaphragm, a movable stopper, and a spring. The first valve includes an inlet formed at an end and connected with the outfall, at least one slot formed at a bottom side of the inlet, and a coupling end formed at the other end thereof and having an external thread. The second valve includes a coupling portion formed at an end thereof and having a larger diameter than that of the coupling end of the first valve, and an outlet formed at the other end thereof for connecting a hose. The coupling portion of the second valve has a thread hole for threadedly connecting the coupling end of the first valve and a recess formed in the thread hole. The outlet is provided with an outlet hole running therethrough, and an annular fringe formed radially in the outlet hole. A stepped portion is radially formed between the thread hole and the outlet hole, having a plurality of vent holes running therethrough for communicating with outside. The circular diaphragm includes at least one through hole formed at a center thereof, being jammed in the recess of the second valve. The movable stopper is mounted below the circular diaphragm, having a stopping member for covering the through hole of the circular diaphragm. The spring includes two ends contacting respectively against the movable stopper and the annular fringe of the outlet of the second valve for generating resilience. Therefore, when the outfall starts watering, the water can successfully pass through the self-draining vacuum breaker and then flow into the hose; when the outfall stops watering, the air can be brought through the self-draining vacuum breaker and then into the hose to eliminate the vacuum.

### BRIEF DESCRIPTION OF THE DRAWINGS

FIG. 1 is an exploded view of a conventional self-draining vacuum breaker.

FIG. 2 is an exploded view of a preferred embodiment of the present invention.

FIG. 3 is a perspective view of the preferred embodiment of the present invention.

FIG. 4 is a sectional view of the preferred embodiment of the present invention.

FIG. 5 is similar to FIG. 4, showing that the water is flowing through the self-draining vacuum breaker of the present invention.

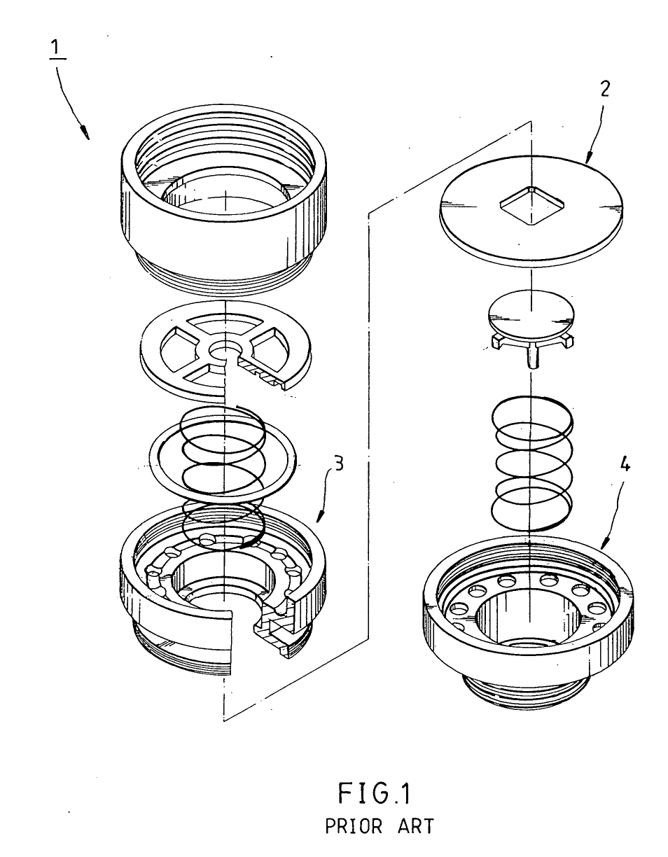

### DETAILED DESCRIPTION OF PREFERRED EMBODIMENTS

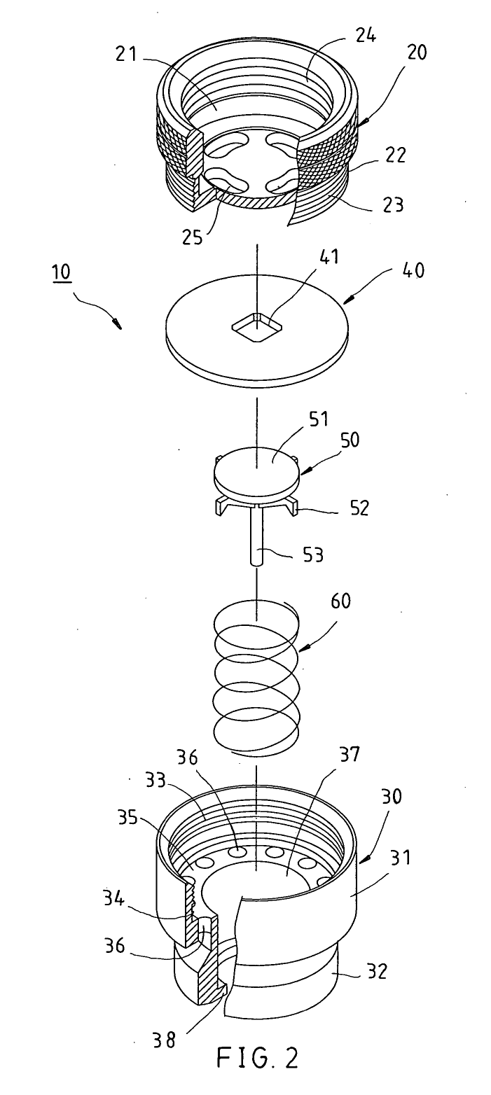

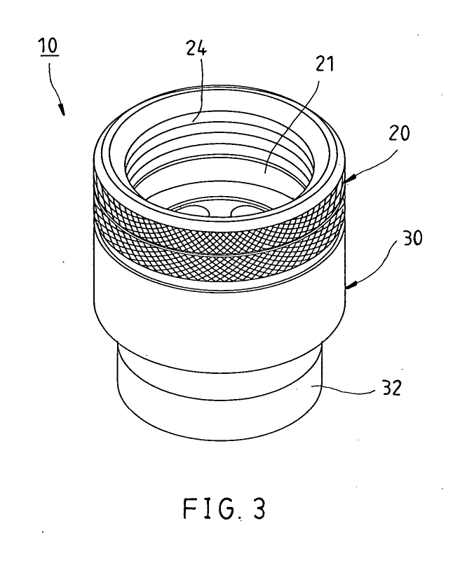

Referring to FIGS. 2-4, a self-draining vacuum breaker 10 constructed according to a preferred embodiment of the present invention is comprised of a tubular first valve 20, an internally-stepped tubular second valve 30, a circular diaphragm 40, a movable stopper 50, and a spring 60.

The first valve 20 includes an inlet 21 formed at an end thereof for connecting a faucet (not shown) or an outfall (not shown) and having an internal thread 24, and a coupling end 22 formed at the other end thereof and having an external thread 23. The inlet 21 is provided with four slots 25 formed at a bottom side thereof.

The second valve 30 includes a coupling portion 31, which is formed at an end thereof and which diameter is larger than that of the coupling end 22, and an outlet 32 formed at the other end thereof for connecting a hose (not shown). The coupling portion 31 has a thread hole 33 axially extending inwards for threadedly connecting the coupling end 22, and an annular recess 34 formed at a bottom end of the thread hole 33 for jamming the circular diaphragm 40. The diameter of the annular recess 34 is larger than that of the thread hole 33. The outlet 32 has an outlet hole 37, which axially runs through the second valve 30 and which diameter is smaller than that of the thread hole 33, and an annular fringe 38 radially formed at a bottom end of the outlet hole 37. The outlet hole 37 communicates with the thread hole 33. An annular stepped portion 35 is radially formed between the thread hole 33 and the outlet hole 37, having a plurality of vent holes 36 arranged annularly thereon and running therethrough for communicating with outside. Each of the vent holes 36 has an imaginary axis parallel to an imaginary long axle of the second valve 30.

The circular diaphragm 40 is made of soft material and is jammed in the annular recess 34, having a through hole 41 formed at a center thereof. The coupling end 22 is threadedly connected with the coupling portion 31 to further tightly clamp the circular diaphragm 40 therebetween, such that the circular diaphragm 40 can be held in sufficient strength.

The movable stopper 50 includes a stopping member 51 for covering the through hole 41 of the circular diaphragm 40, four claw-like lugs 52 formed at a bottom edge thereof for frictionally contacting against a periphery of the outlet hole 37, and a post 53 formed at a bottom side thereof for holding the spring 60 in a proper position.

The spring 60 is a compression spring, having two ends respectively jammed with the claw-like lugs 52 and lying against the annular fringe 38 for generating an upward biasing resilience.

Referring to FIG. 5, when the outfall (not shown) is start watering, the water first flows through the slots 25 of the first valve 20 and then the through hole 41 of the circular diaphragm 40; meanwhile, the water respectively pushes the circular diaphragm 40 and the stopping member 51 of the movable stopper 50 downwards by its gravity respectively to enable the circular diaphragm 40 to be deformed downwards to cover and seal the vent holes 36 for preventing the water from flowing out of the vent holes 36 and to elastically compress the spring 60. Finally, the water flows through the outlet holes 37 and then into the hose (not shown).

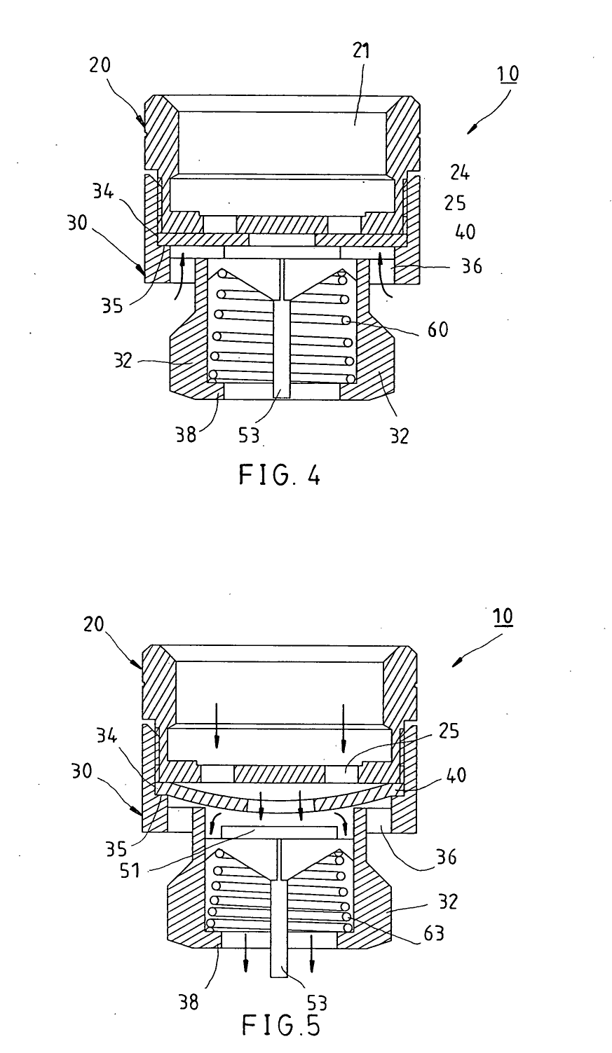

When the outfall stops watering, the spring 60 elastically recovers its length and the circular diaphragm 40 also recovers its shape, as shown in FIG. 4. In the meantime, the vent holes 36 are open again and the outside air flows through the vent holes 36 and into the hose (not shown), thereby eliminating the vacuum formed inside the hose (not shown) in a short time and further draining the water remaining in the hose (not shown).

In addition, the circular diaphragm 40 has its periphery jammed in the annular recess 34 of the second valve 30 and is further clamped tight by the threaded connection of the coupling end 22 of the first valve 20 and the coupling portion 31 of the second valve 30. Therefore, the circular diaphragm 40 is clamped sufficiently tight to be durably secured in position to prevent departure from the proper position, such that the present invention can be greatly reliable.

What is claimed is:

1. A self-draining vacuum breaker connected between an outfall and a hose, said self-draining vacuum breaker comprising:
a tubular first valve having an inlet formed at an end thereof for connecting said outfall, and a coupling end formed at the other end thereof, said inlet having a slot formed at a bottom side of said inlet, said coupling end having an external thread;
a stepped tubular second valve having a coupling portion formed at its one end and an outlet formed at its the other end, said coupling portion having a larger diameter than that of said coupling end of said first valve, a thread hole threadedly connected with said coupling end of said first valve, and a recess formed in said thread hole, said outlet provided for connecting said hose and having an outlet hole and an annular fringe formed in said outlet hole, said thread hole communicating with said outlet hole, a stepped portion being formed between said thread hole and said outlet hole, said stepped portion having a plurality of vent holes for communicating with outside;
a circular diaphragm having a through hole at its center and jammed in said recess of said second valve;
a movable stopper mounted below said circular diaphragm and having a stopping member for covering said through hole of said circular diaphragm; and
a spring having two ends respectively contacting against said movable stopper and lying against said annular fringe of said outlet of said second valve for generating biasing resilience.

2. The self-draining vacuum breaker as defined in claim 1, wherein said vent holes of said stepped portion of said second valve each comprise an imaginary axis parallel to an imaginary long axle of said second valve.

3. The self-draining vacuum breaker as defined in claim 1, wherein said recess of said second valve is larger in diameter than said thread hole.

4. The self-draining vacuum breaker as defined in claim 1, wherein said circular diaphragm is made of a soft material.

5. The self-draining vacuum breaker as defined in claim 1, wherein said circular diaphragm comprises one through hole.

6. The self-draining vacuum breaker as defined in claim 1, wherein said stopping member is formed at an end of said movable stopper, said movable stopper further comprising a plurality of claw-like lugs formed at the other end thereof and holding an end of said spring and contacting against a periphery of said outlet hole.
